(19) United States
(12) Patent Application Publication
(10) Pub. No.: US 2009/0268032 A1
(43) Pub. Date: Oct. 29, 2009

(54) CAMERA SYSTEM

(76) Inventors: Robert Victor Jones, Victoria (AU); Gianni Caldera, Victoria (AU)

Correspondence Address: EDWIN D. SCHINDLER, FIVE HIRSCH AVENUE, P.O. BOX 966, CORAM, NY, 11727-0966, US

(21) Appl. No.: 10/598,111

(22) PCT Filed: Feb. 18, 2005
(86) PCT No.: PCT/AU05/00221

§ 371 Date: Apr. 16, 2009

(30) Foreign Application Priority Data
Feb. 19, 2004 (AU) 2004900854

(51) Int. Cl. H04N 5/33; H04N 5/225

(52) U.S. Cl. 348/164; 348/376; 348/372; 348/E05.024; 348/E05.09

(57) ABSTRACT

A camera apparatus, which can be worn on a person and provides hands-free operation, includes a housing for a camera and a mounting device for the housing on a person. The camera apparatus is able to transmit video signals and may also transmit and receive audio signals.

### AREA OF THE INVENTION

This invention relates to the area of personal security in venues where generally security is provided by a combination of electronic surveillance and persons employed to ensure that security is maintained and in particular to a camera device to effect such surveillance. The area of the invention relates to crowd control in night clubs and other such public places although the application of the invention can include any venues where security is required such as hospitals and prisons among others.

### BACKGROUND TO THE INVENTION

While the concept of the invention has many applications for convenience sake it will be discussed herein with reference to its application to crowd management in entertainment venues.

Over the years there has been a progressive liberalisation in the opening hours of entertainment venues of all kinds and in particular licensed venues such as night clubs and the like. In addition, with the advent of a pronounced drug culture, such venues have been known to attract violence from gangs and/or from people affected by alcohol and/or drugs.

The practice has been that security is provided by privately employed security personnel to implement crowd control while surveillance has been provided by security cameras.

It has been known that security cameras in the numbers generally distributed about public venues do not provide adequate coverage of the area to be secured thereby permitting drug transactions to be carried out and violence to be perpetrated in so called “black spots”. In addition the activities of security personnel are difficult to monitor in such circumstances.

While many feel that there are deficiencies in this training the additional problems of poor surveillance techniques previously discussed still remain to hamper efforts to maintain adequate control of crowds. In particular a door guard would have difficulty identifying a potential troublemaker unless that person happened to be aware of the identity of all people entering a premises.

### OUTLINE OF THE INVENTION

It is an object of this invention to provide a means whereby better surveillance equipment and techniques are available to those providing security services of the type describes above.

The invention provides a camera device which can be worn on a person and provides hands free operation, said camera device including a housing for a camera and means for mounting this housing on a person and also including means to transmit video signals and means for transmitting and receiving audio signals.

It is preferred that the device of the invention include a housing for a miniature colour camera and a directional microphone which is preferably worn on the user's ear level with the user's line of sight.

It is further preferred that the camera device be associated with LED illuminators and be infra-red sensitive and include an optical sensor to enable the camera to switch to infra-red mode when lighting levels are insufficient.

It is preferred that the camera device of the invention be connected to a transmitter kit which includes a wireless RF transmitter module and a battery pack which is preferably rechargeable. It is further preferred that this transmitter kit be able to be worn on by a person, preferably in a holster on a belt.

It is further preferred that video data recorded be transmitted to a secure storage medium which provides incident alerting and monitoring by a centralised security system.

The camera device of the invention therefore provides a supplementary security system, which may be used in conjunction with other security systems associated with a venue, which may include means to scan the identity of a person.

In order that the invention may be more readily understood we shall describe by way of non limiting example a particular embodiment of the invention with reference to the accompanying drawings

### DESCRIPTION OF THE DRAWING FIGURES

FIG. 1 Shows an example of an embodiment of the camera device of the invention as worn by a user;

FIG. 2 Shows a view of an inner side of the camera device;

FIG. 3 Shows a view of an outer side of the camera device;

FIG. 4 Shows an exploded view of the camera device;

FIG. 5 Shows a block diagram of the use of the camera device in a security system

### BRIEF DESCRIPTION OF AN EMBODIMENT OF THE INVENTION

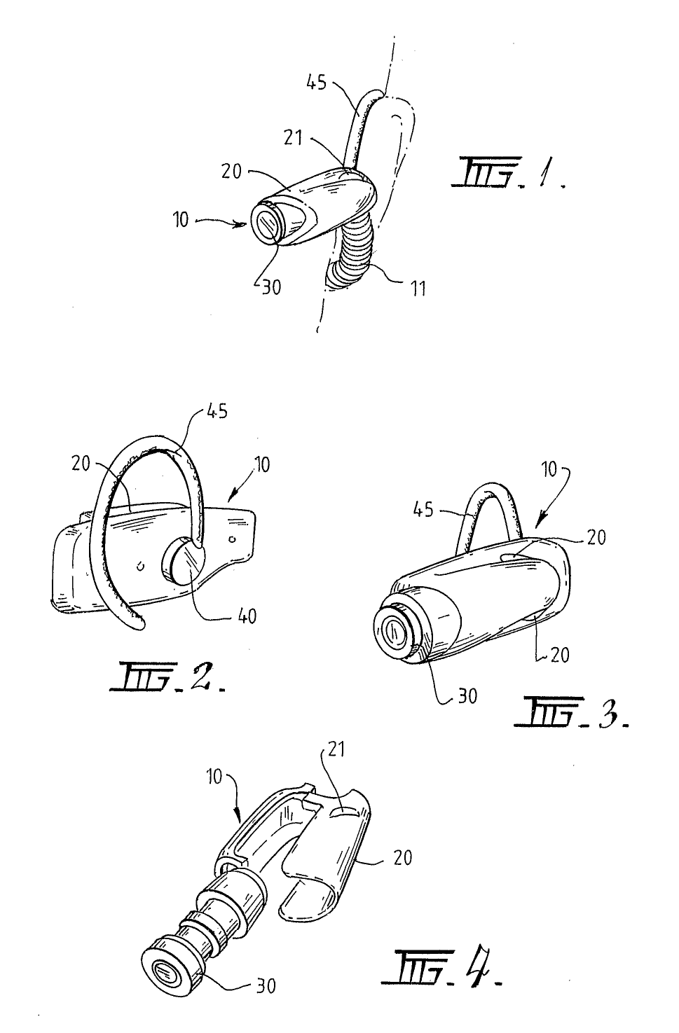

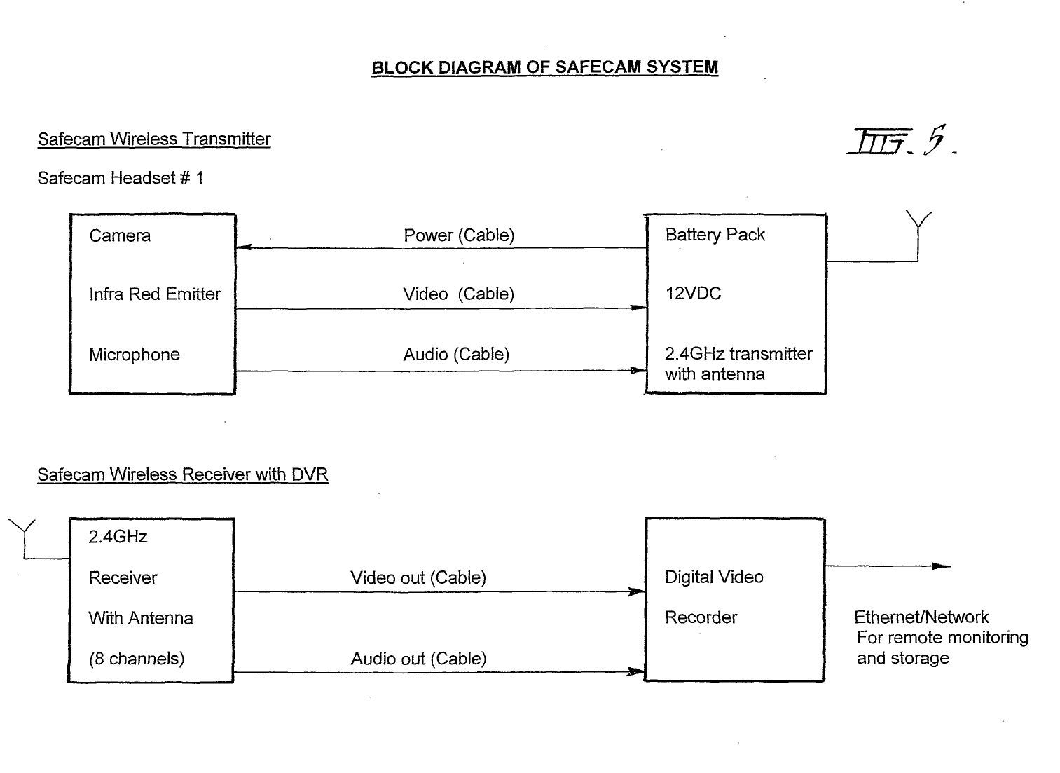

The invention 10 as shown in FIG. 1 includes a housing 20 for a miniature wireless video camera 30 with an associated audio device having an ear piece 40 mounted on a support arm 45 adapted to pass over the ear of the wearer.

In the embodiment of the invention shown the ear piece 40 is located at one end of the support arm 45 however depending on the preferred position of the camera device the camera housing may be positioned anywhere on the support arm.

The invention is a camera device 10 providing a mobile CCTV camera 30 in a housing 20 that can be worn on the any part of the person to provide live visual and audio monitoring/communications in the first person perspective.

The camera device is small and lightweight providing hands free operation to enable a user to interact with and react to the situation at hand while at the same time recording everything they are seeing for later analysis or viewing.

The mini colour camera 30 includes a miniature directional microphone that is worn on the ear, generally level with the wearer's line of sight. LED (Light-Emitting Diode) illuminators 21 and infra-red emitters give the Mobile Camera coverage of approximately 5 meters.

The mini colour camera 30 is Infrared sensitive and has maximum lighting sensitivity. An in-built optical sensor also enables the mobile camera to switch to black and white mode when lighting conditions deteriorate. The functioning of the camera device is controlled by an integrated circuit inside its housing.

The camera device 10 is connected by cable means 11 to a transmitter kit that consists of a wireless RF transmitter module and a re-chargeable battery pack as shown in FIG. 5 to produce an interactive system between the wearer of the camera device and a base station. The battery pack uses high capacity rechargeable batteries that can provide up to 8 hours of continuous use. This transmitter kit contents are contained within an equipment holster that can be worn comfortably on the wearer's belt or as a harness.

Wireless transmission works over selected channels using an international standard. The camera device has a filtering system which has been developed to eliminate and/or reduce the effects from other external systems (e.g. radio communications systems) and from induced or conducted transients such as lighting, strong electromagnetic radiation or mains-generated surges.

The interactive system allows for digital AV data to be directed to a range of devices or locations including personal computers, laptops, portable digital video recording devices, digital video equipment, television networks or central surveillance centres, that can be monitored by specialised security personnel 24 hours a day, 7 days a week.

Connections and data transmissions from any premises under protection can be established in real-time using a wide range of transmission platforms ranging from fixed Internet systems, high-speed GSM (Global Systems of Mobile Communications), LAN (Local Area Networks), ISDN (Integrated Services Digital Networks), Satellite and ADSL (Asymmetric Digital Subscriber Line).

By using the camera device interactive system security personnel become fully mobile self-contained security points that could possibly be equipped with an additional facial recognition system. This will allow greater perimeter control and situational awareness individually or as a group controlled through 2-way communication.

While we have described here a particular embodiment of the invention and discussed its use in a system to assist people engaged in security type occupations the invention has many applications and could be used by correctional staff in prisons, by nurses and other medical staff in hospitals or any other people in danger of assault or wishing to prevent illegal activity. Presumably such monitoring could also have fairly general application and include anywhere where it may be difficult to otherwise obtain people's identities such as perhaps nursing homes.

The camera device of the invention is not restricted as to shape and materials from which it is made or the means used to effect the audio and visual transmission. While it may be worn anywhere on one's person it is preferred that the camera actually record as nearly as possible what the wearer is seeing at the time and for this reason the ear mounted embodiment described has been preferred as the aural communication is most effective in this manner.

There is however no restriction on where or how the camera device or any associated transmission equipment are worn and it is envisaged that an integral unit may be devised.

The concept of the invention therefore can have many forms and different applications and while we have described herein one particular embodiment of the invention it is to be understood that variations and modifications in the features described can still lie within the scope of the invention.

1-11. (canceled)

12. A camera apparatus able to be worn on a person and providing hands-free operation, comprises:
a camera;
a housing for said camera;
means for mounting said housing on a person so that said housing containing said camera is able to be worn by the person;
means for transmitting video signals; and,
means for transmitting and receiving audio signals.

13. The camera apparatus able to be worn on a person and providing hands-free operation according to claim 12, further comprising a directional microphone included with said camera.

14. The camera apparatus able to be worn on a person and providing hands-free operation according to claim 12, wherein said means for mounting said housing on a person includes a support arm passable over an ear of the person, so that said camera is substantially level with a line of sight of the person.

15. The camera apparatus able to be worn on a person and providing hands-free operation according to claim 14, further comprising an earpiece connected to said support arm with aural transmission to the person effected via said earpiece.

16. The camera apparatus able to be worn on a person and providing hands-free operation according to claim 12, wherein said camera includes an infra-red sensitive mode.

17. The camera apparatus able to be worn on a person and providing hands-free operation according to claim 16, wherein said camera includes an optical sensor for switching said camera to said infrared sensitive mode when lighting levels are insufficient for non-infra-red operation.

18. The camera apparatus able to be worn on a person and providing hands-free operation according to claim 12, wherein functions for said camera are controlled by an integrated circuit in said housing.

19. The camera apparatus able to be worn on a person and providing hands-free operation according to claim 12, wherein said means for transmitting and receiving audio signals includes a wireless RF transmitter module and a battery pack.

20. The camera apparatus able to be worn on a person and providing hands-free operation according to claim 12, wherein said means for transmitting video signals includes means for transmitting video data recorded by said camera to a secure storage medium.
